(19) United States
(12) Patent Application Publication
(10) Pub. No.: US 2023/0365065 A1
(43) Pub. Date: Nov. 16, 2023

(54) POWER GENERATION SYSTEM

(71) Applicant: STEWART & STEVENSON LLC, Houston, TX (US)

(72) Inventors: Brian SHARP, Houston, TX (US); Chris HARVELL, Houston, TX (US); Chad JOOST, Houston, TX (US)

(21) Appl. No.: 18/197,557

(22) Filed: May 15, 2023

Related U.S. Application Data
(60) Provisional application No. 63/342,546, filed on May 16, 2022.

(51) Int. Cl. B60R 3/00; B62D 33/04; F16M 3/00; A62B 35/00; H02K 7/18

(52) U.S. Cl. CPC B60R 3/005; B62D 33/04; F16M 3/00; A62B 35/0056; A62B 35/0018; H02K 7/1815

(57) ABSTRACT

A trailer-mounted power generation system that includes an enclosure having a roof, sides, end walls, and a floor adapted to be transported by a platform, and a generator positioned within the enclosure, the generator including an engine. The trailer-mounted power generation system also includes a ladder and fall arrest system.

### CROSS-REFERENCE TO RELATED APPLICATIONS

This application is a nonprovisional application which claims priority from U.S. provisional application No. 63/342,546, filed May 16, 2022, which is incorporated by reference herein in its entirety.

### TECHNICAL FIELD/FIELD OF THE DISCLOSURE

The present disclosure relates generally to mobile power generation equipment.

### BACKGROUND OF THE DISCLOSURE

Power generation equipment is used in a number of industries. For example, power generation equipment may be used in fracturing operations to run electrical equipment. When power generation equipment is used, it may be advantageous that the power generation equipment be mobile and accessible.

### SUMMARY

The disclosure includes a trailer-mounted power generation system that includes an enclosure having a roof, sides, end walls, and a floor adapted to be transported by a platform, and a generator positioned within the enclosure, the generator including an engine. The trailer-mounted power generation system also includes a ladder and fall arrest system.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a trailer-mounted power generation system consistent with at least one embodiment of the present disclosure.

FIG. 2 is a partially transparent side view of the power generation system of FIG. 1 mounted on a trailer.

FIG. 3 is a drawing of a harness consistent with some embodiments of the present disclosure.

FIG. 4 is a perspective view of the rear of a trailer-mounted power generation system of FIG. 1 consistent with certain embodiments of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

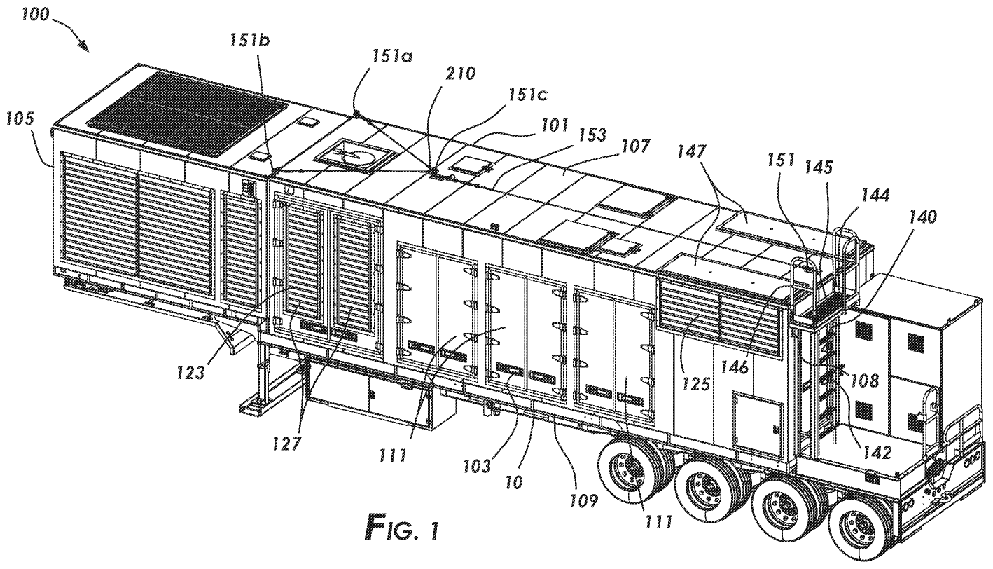

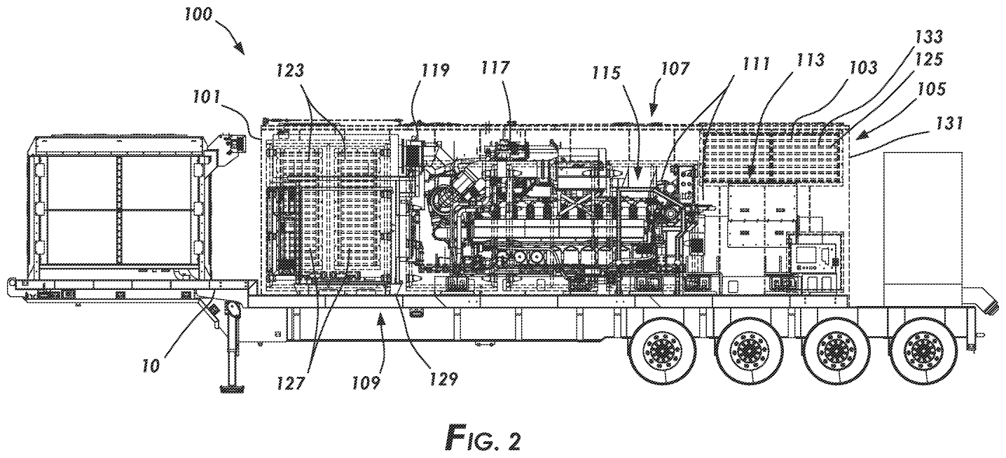

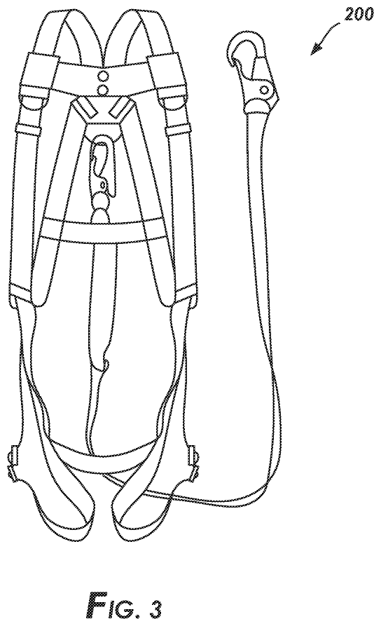

FIGS. 1-4 depict trailer-mounted power generation system 100 consistent with at least one embodiment of the present disclosure. Trailer-mounted power generation system 100 may include enclosure 101. Enclosure 101 may be formed such that trailer-mounted power generation system 100 may be transported by platform 10, which may be, for example and without limitation, a trailer, truck, or other mobile platform. Enclosure 101 may include side walls 103, end walls 105, roof 107, and floor 109. In some embodiments, one or more of side walls 103, end walls 105, and roof 107 may include one or more access doors 111. Access doors 111 may be positioned to allow access to the interior of enclosure 101 such as to allow for access to generator 113 positioned within enclosure 101 (shown in FIG. 2). In some embodiments, generator 113 may include engine 115. Engine 115 may be any suitable prime mover usable to run generator 113 and may include, for example and without limitation, one or more of a diesel, gasoline, or natural gas powered internal combustion, turbine, or other engine. Engine 115 may include engine block 117 and exhaust system 119. Trailer-mounted power generation system 100 may be designed such that engine 115 is completely encapsulated by enclosure 101 and may operate with access doors 111 in an open or closed position.

In some embodiments, enclosure 101 may include one or more intake vents 123 and one or more exhaust vents 125. In some embodiments, intake vents 123 may be positioned on side walls 103. In some embodiments, intake vents 123 may be positioned on louvred doors 127. In some embodiments, louvred doors 127 may be openable to provide access to the interior of enclosure 101 but may remain closed during operation of engine 115. In other embodiments, air intake vents 123 may be positioned within enclosure 101 or may be positioned on end walls 105 or roof 107. In some embodiments, intake vents 123 may include an additional device such as, for example and without limitation, a snorkel. In some embodiments, trailer-mounted power generation system 100 may include transformer 129 positioned within enclosure 101 adjacent intake vents 123.

In some embodiments, exhaust vents 125 may be positioned on side walls 103 at an end of enclosure 101 opposite intake vents 123 such that air flow from intake vents 123 to exhaust vents 125 may pass across engine 115. In some embodiments, exhaust vents 125 may include exhaust fans 131. In some embodiments, exhaust fans 131 may be driven by variable-speed motors 133 (shown in FIG. 2).

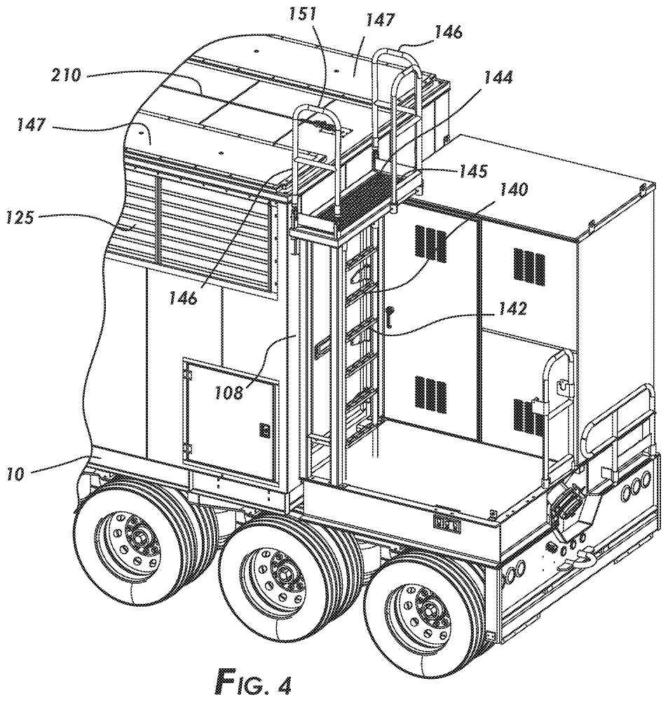

In certain embodiments, trailer-mounted power generation system 100 includes ladder and fall arrest system 140. Ladder and fall arrest system 140 may include, as shown in FIG. 1, fixed ladder 142, landing area 144, and a fall arrest system 210. Fixed vertical ladder 142 and landing area 144 are shown in more detail in FIG. 4. In the embodiment shown in FIG. 4, landing area 144 includes landing platform 145, affixed to rear 108 of enclosure 101, such as by welding or mechanical attachment. Landing area 144 may also include handrails 146 welded or mechanically affixed to platform 145 or welded or mechanically affixed to rear 108 of enclosure 101.

In certain embodiments, ladder 142 may be welded or affixed to rear 108 of enclosure 101 or welded or mechanically affixed to platform 145 such that ladder 142 is fixed in place.

In certain embodiments, landing area 144 may also include one or more plates 147 welded or mechanically affixed to roof 107. In the embodiment shown in FIGS. 1 and 4, plates 147 are arranged on either side of platform 145. Plates 147 may be used to provide a level space for the user to place service items or for the user to stand while fitting harness 200.

Fall arrest system 210 may include at least two enclosure securement points 151 and one cord 153. Cord 153 is connected to the at least two enclosure securement points 151. In the embodiment shown in FIG. 1, fall arrest system 210 includes four enclosure securement points 151. Also, in the embodiment shown in FIG. 1, two additional cords 153 are connected between enclosure securement point 151a and 151c, and 151b and 151c to form a “Y.” In fall arrest system 210, harness 200 may be affixed along cord 153 to arrest potential falls by an operator. The “Y” formed from cords 153 in the embodiment shown in FIG. 1 allows the user to reach different points along roof 107. As one of ordinary skill in the art with the benefit of this disclosure would understand, the non-limiting configuration of fall arrest system 210 may be altered without departing from this disclosure.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A trailer-mounted power generation system comprising:
an enclosure having a roof, sides, end walls, and a floor adapted to be transported by a platform;
a generator positioned within the enclosure, the generator including an engine;
a ladder and fall arrest system.

2. The trailer-mounted power generation system of claim 1, wherein the ladder fall and arrest system includes:
a fixed ladder, the fixed ladder affixed to a rear of the enclosure, the fixed ladder having a top;
a landing area, the landing area including:
a landing platform, the landing platform having sides and affixed to the rear of the enclosure; and
handrails affixed to the landing platform or the rear of the enclosure.

3. The trailer-mounted power generation system of claim 2, wherein the landing area further includes one or more plates affixed to the roof of the enclosure.

4. The trailer-mounted power generation system of claim 3, wherein the plates are arranged on either side of the platform.

5. The trailer-mounted power generation system of claim 1, wherein the fall arrest system includes:
at least two enclosure securement points;
a cord attached to the at least two enclosure securement points;
a harness affixed to the cord.

6. The trailer-mounted power generation system of claim 5, wherein the fall arrest system includes four enclosure securement points.

7. The trailer-mounted power generation system of claim 6, wherein the enclosure securement points are arranged to form a “Y.”

8. The trailer-mounted power generation system of claim 7, wherein three cords are positioned to connect the segments of the “Y” formed by the four enclosure securement points.
